(19) United States
(12) Patent Application Publication
(10) Pub. No.: US 2014/0305539 A1
(43) Pub. Date: Oct. 16, 2014

(54) METHOD OF DRAINING A FLUID TANK IN A FLUID SEPARATION SYSTEM

(71) Applicant: Aker Subsea AS, Lysaker (NO)

(72) Inventor: Kjell Olav Stinessen, Oslo (NO)

(73) Assignee: AKER SUBSEA AS, Lysaker (NO)

(21) Appl. No.: 14/354,520

(22) PCT Filed: Oct. 17, 2012
(86) PCT No.: PCT/NO2012/050202

§ 371 Date: Apr. 25, 2014

(30) Foreign Application Priority Data
Oct. 27, 2011 (NO) 20111455

(51) Int. Cl. F17D 5/00

(52) U.S. Cl. CPC F17D 5/00
USPC 141/1

(57) ABSTRACT

A method of draining at least one liquid collector in a system for separating and collecting liquid contained in gas from a reservoir, wherein the liquid collector is connected to an outlet from a compressor, and a recirculation circuit between the outlet of the compressor and an inlet from the reservoir to a liquid separator to which the one liquid collector is connected downstream thereof, and which outlet is connected downstream to a transport pipe. The method comprises raising the pressure of the liquid in the e liquid collector to a higher pressure than the pressure in the inlet pipe or the transport pipe, and draining the liquid in the liquid collector upstream either to the inlet pipe or directly to the liquid separator via a first drain line, or alternatively downstream to the transport pipe via a second drain line.

The present invention relates to a method of draining at least one liquid collector in a system for separating and collecting liquid contained in gas from a reservoir, as disclosed in the preamble of claim 1.

By recirculating, sufficient pressure may alternatively be obtained to drain to a mixing point downstream of the compressor.

With reference to Norwegian Patent No. 330768, belonging to the Applicant, there is previously known a system having a liquid collector that is drained by supplying compressed gas from the system's compressor to the liquid collector or by supplying shut-in pressure downstream of the compressor to the liquid collector. A weakness of this system is that if the compressor were to stop or there were no shut-in pressure available, the liquid collector could no longer be drained. If the collector is full when stoppage occurs, it might therefore be overfilled at the start-up of the compressor system, which means that it must be shut down, thereby rendering start-up impossible. Another situation where the collector may be full or partly full is after installation of the compression system where seawater may have leaked in during the installation operation. In such a case, it may be impossible to start the compressor and allow high-pressure gas therefrom into the transport pipe, net outflow, because production of high-pressure gas from the compressor will result in the liquid well stream being passed into the separator and the liquid separator may become overfilled.

The aforementioned and other weaknesses or defects are according to the invention sought to be remedied by means of a method as disclosed in the characterising clause of claim 1.

Advantageous embodiments of the invention are set forth in the dependent claims.

Non-limiting embodiments of the invention are shown in the attached figures, wherein

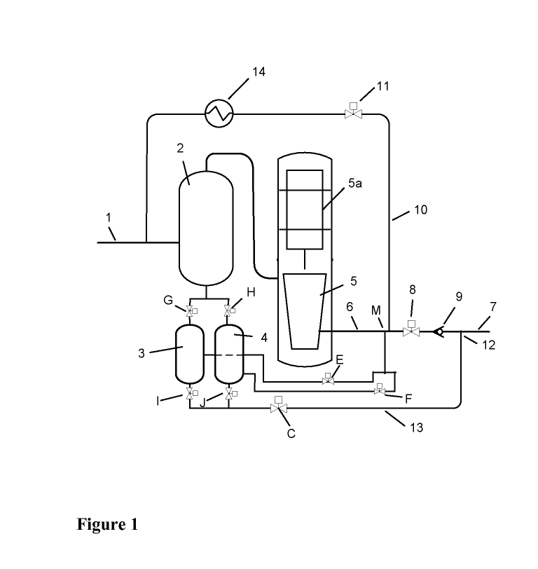

FIG. 1 is a schematic diagram of a first embodiment of the invention, with no need for an emergency drain line;

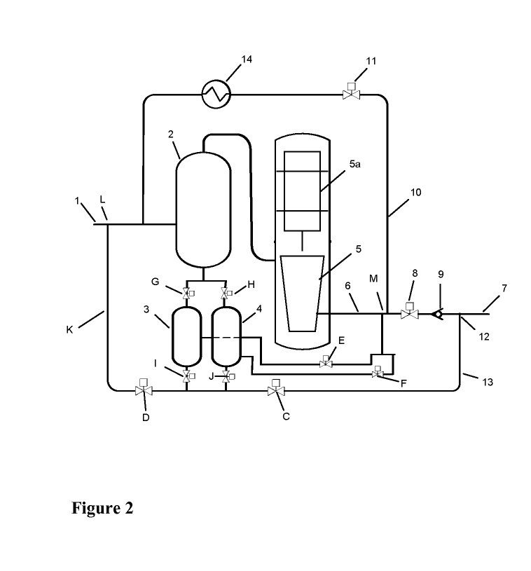

FIG. 2 is a schematic diagram of a second embodiment of the invention, with a need for an emergency drain line; and

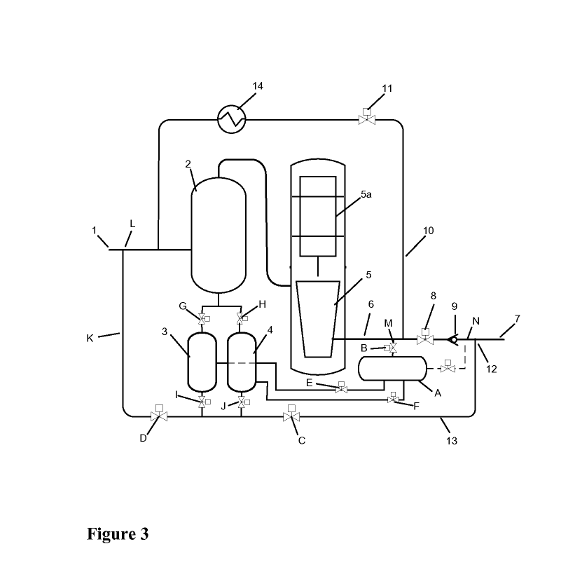

FIG. 3 is a schematic diagram of a third embodiment of the invention, including a pressure accumulator tank.

The meaning of the reference designations that refer to the aforementioned figures and as given in the description below can be seen from the list in Table 1, where the same or similar components or elements are identified by the same reference figures and/or letters.

TABLE 1

| | |
|---|---|
| 1 | Inlet pipe |
| 2 | Liquid separator |
| 3 | Liquid collector |
| 4 | Liquid collector |
| 5 | Compressor |
| 5a | Compressor motor |
| 6 | Outlet pipe |
| 7 | Transport pipe |
| 8 | Valve |
| 9 | Check valve |
| 10 | Recirculation circuit |
| 11 | Valve |
| 12 | Mixing point |
| 13 | Drain line |
| 14 | Heat exchanger |
| A | Pressure accumulator tank |
| B | Valve |
| C | Valve |
| D | Valve |
| E | Valve |
| F | Valve |
| G | Valve |
| H | Valve |
| I | Valve |
| J | Valve |
| K | Pipe for emergency draining to a point upstream of separator |
| | or into separator |
| L | Mixing point |
| M | Take-off point for high-pressure drain gas |
| N | Alternative drain gas take-off point |

Referring initially to FIG. 1, there is shown an inlet pipe 1 that runs from a reservoir to a liquid separator (in the following also referred to as a separator) 2. Separated liquid from the liquid separator 2 is passed to at least one liquid collector, in the illustrated case two liquid collectors 3, 4, whilst gas from the liquid separator is passed to a compressor 5, with motor 5a, downstream of the liquid separator 2, as is also known from Norwegian Patent No. 330768, which belongs to the Applicant. Outgoing, compressed gas from the compressor is passed to outlet pipe 6 and is then passed towards the shore through a transport pipe 7 after passing through a valve 8 with actuator and a check valve 9.

From the outlet pipe 6, immediately behind the compressor 5, there runs a recirculation circuit 10 (“anti surge”) which passes gas back to the inlet pipe 1 upstream of the liquid separator 2, the recirculation circuit including a valve with actuator 11 which in the direction of flow is followed by a heat exchanger 14 for cooling recirculated gas by heat exchange with the surrounding seawater.

During normal operation where compressed gas, pressure gas, from the compressor is passed into the transport pipe 7 such that it has net outflow and does not only go to recirculation without production, gas from the liquid separator 2 will be drained in that gas at compressor outlet pressure, pressure gas from a take-off point M (or alternatively N, see FIG. 3), forces liquid out of the liquid collectors b 3, 4 when valve G or valve H is closed and valve I or valve J is open and valve E or valve F is open and valve C is open. To ensure efficient outflow from the liquid collectors 3, 4 to the mixing point 12 in the transport pipe 7 via drain line 13, valve 8, for example, may have a certain flow restriction or a specific flow restriction may be inserted at the mixing point 12 in order to obtain a driving pressure drop from the outlet of the liquid collectors 3, 4 to the mixing point 12, typically 1 to 3 bar. In certain cases, there may be a sufficient drop in pressure through equipment from the outlet of the compressor 5 up to the mixing point 12 such that a separate flow restriction will be unnecessary. This may be the case if a (non-illustrated) gas outlet cooler is mounted between the compressor 5 outlet and ahead of the mixing point 12. Another way of obtaining a driving pressure drop is to provide a constriction that gives rise to negative pressure, e.g., a Laval or Venturi nozzle or orifice, in the transport pipe 7 at the mixing point 12 where the liquid flows in.

Furthermore, with reference to FIGS. 2 and 3, in cases where the compressor 5 has stopped and there is a need for draining of the liquid collectors 3, 4, there may be provided a drain line K (referred to in the following also as an emergency drain line) capable of passing liquid to a mixing point L upstream of the separator 2.

Emergency Draining Method 1, With No Need for an Emergency Drain Line (FIG. 1):

In connection with controlled shut-down of the compressor 5, and to ensure that the liquid collectors 3, 4 are empty before the next start-up, the compressor 5 can be put into recirculation, with valve 8 closed, and the recirculation/anti-surge valve 11 may be set at such flow restriction that the outlet pressure for the recirculated gas in recirculation pipe 10 is higher than the pressure in the transport pipe 7 and the liquid can in the usual way be drained to the mixing point 12, as described above.

Emergency Draining Method 2, With Emergency Drain Line (FIG. 2):

If it is not possible to choke so much on the valve 11 that the pressure of the recirculated gas in the pipe 10 is higher than the pressure in the pipe 7, draining can be carried out in that an emergency drain line K is installed from the outlet of the liquid collectors 3, 4 to a mixing point L in the inlet pipe 1 upstream of the separator 2. Alternatively, and not illustrated, the emergency drain line K can be run directly into the separator 2. The recirculation pressure in the pipe 10 is then set at a pressure that is higher than the pressure in the inlet pipe 1.

During start-up or stoppage, it is also possible to ensure that the liquid collectors 3, 4 are empty by using the aforementioned emergency draining methods with recirculation before net outflow of gas and thus no net inflow of liquid to the separator 2.

Emergency draining methods 1 and 2 are only possible with take-off point M upstream of the shut-off valve 8 for the compressor 5, and thus for take-off of high-pressure drain gas from the compressor 5.

As an extra assurance that emergency draining will be possible, a pressure accumulator tank A can be introduced, as shown in FIG. 3.

From the outlet pipe 6, preferably immediately after the compressor 5 (in the take-off point M for high-pressure drain gas) or alternatively further down the outlet pipe (in take-off point N for drain gas at lower pressure), after the valve 8 with actuator and the check valve, there runs, according to this embodiment of the invention, a feed pipe to at least one pressure accumulator tank, in the illustrated case a pressure accumulator tank A, where the feed pipe to the pressure accumulator tank A includes a valve B with actuator, whose function will be described below.

From the pressure accumulator tank A, there runs a feed pipe for high-pressure gas to each of the two liquid collectors 3, 4, each of these feed pipes including a respective valve E, F with actuator.

A feed pipe for liquid from the liquid separator 2 to the two liquid collectors 3, 4 branches off before each liquid collector 3, 4, and on each branch there is provided a respective valve G, H with actuator.

In a liquid outlet pipe from each respective liquid collector there are provided two additional valves I, J, the two liquid outlet pipes being connected to a circuit K, 13 which runs between the inlet pipe 1 from the reservoir and the outlet pipe 6 from the is compressor 5, and downstream of the check valve 9 for the latter. Said circuit comprises, in an emergency flow direction towards the inlet pipe 1 from the reservoir, a valve D with actuator, and in a normal flow direction towards the outlet pipe 6 from the compressor 5, a valve C, whose function will also be described below.

It will be understood that with the compressor 5 in operation, there will be a pressure drop across the valve 8 with actuator and the check valve 9, whilst there will be a “confined” pressure downstream of the check valve 9, even when gas is drawn off on or close to the shore.

With a pressure ratio of, for example, 3:1 between the downstream and upstream/suction side of the compressor 5, a pressure of 20 bar in the inlet pipe to the liquid separator 3, 4 will give a pressure after the compressor 5 of 60 bar. The volume in the pressure accumulator tank A is advantageously dimensioned for, for example, three draining operations, and a volume of, for instance, 10 m³ will then, with a pressure of 60 bar, give a pressure volume or “capacity” of 10 m³×60 bar. The pressure accumulator tank A will thus be a tank for storage of gas at the outlet pressure from the compressor 5.

During normal operation and with the compressor 5 in operation, the valves B, C will be open and the valve D will be closed, such that collected liquid in the liquid collectors 3, 4 will be drained to the downstream side of the compressor 5 due to the drop in pressure across the valve 8 with actuator and the check valve 9 arranged in the outlet pipe 6 from the compressor, or a drop in pressure due to other equipment, for example, a (non-illustrated outlet cooler.

Emergency Draining Method 3, With Pressure Accumulator Tank (FIG. 3):

For draining of the liquid collector 4 connected to the valves H, J, the valve H is closed first, after which the valve F is opened so as to allow the liquid collector 4 to be filled with high-pressure gas from the pressure accumulator tank A, after which the valve F is closed again and the valve J is opened for draining of the liquid collector 4. Similar methods apply for alternative draining of the liquid collector 3 connected to the valves G, I, but then with manipulation of the valves E, G and I. During the draining of one of the liquid collectors 3, 4, the filling of the other 4, 3 from the liquid separator 2 will advantageously be able to continue as normal.

During recirculation or compressor stoppage, the valve B will be closed in order to store the pressure in the pressure accumulator tank A as a back-up for draining. During emergency operation, the valves C and B are thus closed, whilst the valve D is opened, to ensure draining to a location with lower pressure, for example, back to the reservoir via the inlet pipe 1.

Although it is not shown in the figures or described in the above, the system may comprise any number of liquid separators, liquid collectors and pressure accumulator tanks In addition, during normal operation with the compressor 5 in operation, high-pressure gas for draining will be taken directly from the compressor 5 (i.e., without going via any pressure accumulator tank A), whilst one or more pressure accumulator tanks ensures pressure for a plurality of draining operations in situations where the compressor 5 is out of service.

The present invention is thus not limited to the aforementioned embodiments, but can be varied within the scope of the attached claims.

1. A method of draining at least one liquid collector arranged downstream of a liquid separator in a system for separating and collecting liquid contained in gas from a reservoir, wherein
the at least one liquid collector is connected to a mixing point downstream of an outlet from a compressor, and
a recirculation circuit is arranged between the outlet, upstream of said mixing point, and an inlet upstream of said liquid separator, and
wherein the outlet is connected downstream to a transport pipe, the method comprising:
either steps A of
raising the pressure of the liquid in the at least one liquid collector to a higher pressure than the pressure in the inlet pipe, and
draining the liquid in the at least one liquid collector upstream to the inlet pipe or directly to the liquid separator via a first drain line,
or steps B of
raising the pressure of the liquid in the at least one liquid collector to a higher pressure than the pressure in the transport pipe, and
draining the liquid in the at least one liquid collector downstream to the transport pipe via a second drain line.

2. The method according to claim 1, further comprising, in the case of steps B, putting the compressor into recirculation and setting a recirculation pressure to higher than the pressure in the transport pipe, and draining the liquid in the at least one liquid collector to the transport pipe via the second drain line.

3. The method according to claim 1, further comprising, in the case of steps A, putting the compressor into recirculation, setting a recirculation pressure to higher than the pressure in the inlet pipe or the liquid separator, and draining the liquid in the at least one liquid collector to the inlet pipe or the liquid separator via the first drain line.

4. The method according to claim 1, further comprising supplying gas from a pressure accumulator tank arranged between the outlet pipe or the transport pipe from the compressor and the at least one liquid collector at a higher pressure than the pressure in the inlet pipe or the transport pipe, and draining the liquid in the at least one liquid collector to either the inlet pipe or the liquid separator via the first drain line, or alternatively to the transport pipe via the second drain line (13), draining taking place independent of whether the compressor is put into recirculation or is in operation since compressed gas from the compressor is available via the pressure accumulator tank.

5. The method according to claim 1, further comprising providing two liquid collectors in two respective branches from the liquid separator and draining liquid alternately from the two liquid collectors, two respective valves (G, H) being arranged in each respective branch upstream of, and two respective valves (I, J) being arranged downstream of, the two liquid collectors, and wherein two respective valves (E, F) are arranged in two respective feed lines for high-pressure gas to the two liquid collectors, where for draining of the liquid collector, the valve (H) is closed first, after which the valve (F) is opened for filling of the liquid collector with high-pressure gas, after which the valve (F) is closed and the valve (J) is opened for draining of the liquid collector, and with corresponding steps for draining liquid collector by the same manipulation of corresponding respective valves (E, G, I) connected to the liquid collector.

6. The method according to claim 1, further comprising, in the case of steps B, providing in the second drain line a valve (C) with actuator, and in the recirculation circuit there is provided a valve (11) with actuator.

7. The method according to claim 1, further comprising, in the case of steps A, providing in the first drain line a valve (D) with actuator, and in the recirculation circuit there is provided a valve (11) with actuator.

8. The method according to claim 1, wherein between the outlet pipe from the compressor and the transport pipe, a valve (8) is arranged downstream followed by a check valve.

9. The method according to claim 1, wherein a gas take-off point (M) for draining of the liquid collectors is arranged in the outlet pipe from the compressor.

10. The method according to claim 8, wherein a take-off point (N) for gas to the pressure accumulator tank is arranged in the transport pipe, a valve (B) being disposed between the take-off point (N) and the pressure accumulator tank.

11. The method according to claim 4, wherein a take-off point (M) for gas to the pressure accumulator tank is arranged in the outlet pipe from the compressor, a valve (B) being disposed between the take-off point (N) and the pressure accumulator tank.

12. The method according to claim 10, wherein, during recirculation or compressor stoppage, closing the valves (C) and (B), and opening the valve (D), for draining via the first drain line to a point with lower pressure, for example, the inlet pipe.
